(19) United States
(12) Patent Application Publication
(10) Pub. No.: US 2025/0380147 A1
(43) Pub. Date: Dec. 11, 2025

(54) SIMULATING A NETWORK NODE, AND TESTING A NETWORK NODE

(71) Applicant: Telefonaktiebolaget LM Ericsson (publ), Stockholm (SE)

(72) Inventor: Jonas KARLSSON, Upplands Väsby (SE)

(21) Appl. No.: 18/878,432

(22) PCT Filed: Jun. 20, 2023
(86) PCT No.: PCT/EP2023/066619

§ 371 Date: Dec. 23, 2024

Related U.S. Application Data
(60) Provisional application No. 63/355,756, filed on Jun. 27, 2022.

(51) Int. Cl. H04W 16/22; H04W 24/06

(52) U.S. Cl. CPC H04W 16/22; H04W 24/06

(57) ABSTRACT

In an example, a method of simulating a first network node is provided. The method includes receiving information representing signals from a second network node, wherein the information representing signals includes information representing signals received by the second network node from one or more User Equipments (UEs), simulating a demodulation operation on the information representing signals to obtain information representing demodulated signals, and simulating a decoding operation on the information representing demodulated signals to obtain decoded data.

### TECHNICAL FIELD

Example embodiments of this disclosure relate to simulating or testing a network node, such as a Distributed Unit (DU), Radio Equipment Controller (REC), Radio Unit (RU) or Radio Equipment (RE).

### BACKGROUND

One of the aims of the Open Radio Access Network (O-RAN) Alliance is to standardize a so-called lower layer split, see for example O-RAN WG4 specifications, https://www.o-ran.org/specifications. This split defines an interface between radio equipment controller (REC) and radio equipment (RE) in a radio access network (RAN) communication system. There are several different ways the functional division can be done between the REC and RE, see for example 3GPP TR 38.816 V15.0.0, “Study on CU-DU lower layer split for NR.”

The O-RAN specification has chosen a split that is close to the 7-2 functional split (as defined in the O-RAN WG4 specifications referred to above). For the uplink, this means that FFT/CP removal, beamforming and resource element de-mapping are located in the RE, and that channel estimation/equalization, IDFT, de-modulation and decoding are located in the REC. One possible improvement involves moving channel estimation, and potentially also equalization, to the RE.

### SUMMARY

To efficiently test network nodes, it may be advantageous to be able to test different network nodes separately. For example, for a specific functional split between network nodes, such as between a REC and RE, it may be advantageous to define specific, well-defined network node simulators that can be used both for general testing and formal conformance and compliance testing.

One aspect of the present disclosure provides a method of simulating a first network node. The method comprises receiving information representing signals from a second network node, wherein the information representing signals comprises information representing signals received by the second network node from one or more User Equipments (UEs), simulating a demodulation operation on the information representing signals to obtain information representing demodulated signals, and simulating a decoding operation on the information representing demodulated signals to obtain decoded data.

A further aspect of the present disclosure provides a method of testing a second network node. The method comprises performing a method of simulating a first network node according to the above aspect, and determining a test result of testing the second network node based on the decoded data.

Another aspect of the present disclosure provides a method of simulating a second network node. The method comprises generating information representing signals, wherein the information representing signals emulates signals received by the second network node from one or more User Equipments (UEs), and providing the information representing signals to a first network node.

A still further aspect of the present disclosure provides a method of testing a first network node. The method comprises performing a method of simulating a second network node according to the above aspect, and determining a test result of testing the first network node based on an output of the first network node.

An additional aspect of the present disclosure provides apparatus for simulating a first network node, the apparatus comprising a processor and a memory, the memory containing instructions executable by the processor such that the apparatus is operable to receive information representing signals from a second network node, wherein the information representing signals comprises information representing signals received by the second network node from one or more User Equipments (UEs), simulate a demodulation operation on the information representing signals to obtain information representing demodulated signals, and simulate a decoding operation on the information representing demodulated signals to obtain decoded data.

An additional aspect of the present disclosure provides apparatus for testing a second network node, the apparatus comprising a processor and a memory, the memory containing instructions executable by the processor such that the apparatus is operable to receive information representing signals from a second network node, wherein the information representing signals comprises information representing signals received by the second network node from one or more User Equipments (UEs), simulate a demodulation operation on the information representing signals to obtain information representing demodulated signals, simulate a decoding operation on the information representing demodulated signals to obtain decoded data, and determining a test result of testing the second network node based on the decoded data.

An additional aspect of the present disclosure provides apparatus for simulating a second network node, the apparatus comprising a processor and a memory, the memory containing instructions executable by the processor such that the apparatus is operable to generate information representing signals, wherein the information representing signals emulates signals received by a second network node from one or more User Equipments (UEs), and provide the information representing signals to a first network node.

An additional aspect of the present disclosure provides apparatus for testing a first network node, the apparatus comprising a processor and a memory, the memory containing instructions executable by the processor such that the apparatus is operable to generate information representing signals, wherein the information representing signals emulates signals received by a second network node from one or more User Equipments (UEs), provide the information representing signals to a first network node, and determining a test result of testing the first network node based on an output of the first network node.

An additional aspect of the present disclosure provides apparatus for simulating a first network node, the apparatus configured to receive information representing signals from a second network node, wherein the information representing signals comprises information representing signals received by the second network node from one or more User Equipments (UEs), simulate a demodulation operation on the information representing signals to obtain information representing demodulated signals, and simulate a decoding operation on the information representing demodulated signals to obtain decoded data.

An additional aspect of the present disclosure provides apparatus for testing a second network node, the apparatus configured to receive information representing signals from a second network node, wherein the information representing signals comprises information representing signals received by the second network node from one or more User Equipments (UEs), simulate a demodulation operation on the information representing signals to obtain information representing demodulated signals, simulate a decoding operation on the information representing demodulated signals to obtain decoded data, and determining a test result of testing the second network node based on the decoded data.

An additional aspect of the present disclosure provides apparatus for simulating a second network node, the apparatus configured to generate information representing signals, wherein the information representing signals emulates signals received by the second network node from one or more User Equipments (UEs), and provide the information representing signals to a first network node.

An additional aspect of the present disclosure provides apparatus for testing a first network node, the apparatus configured to generate information representing signals, wherein the information representing signals emulates signals received by a second network node from one or more User Equipments (UEs), provide the information representing signals to a first network node, and determining a test result of testing the first network node based on an output of the first network node.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method of simulating a first network node;

FIG. 2 is a flow chart of an example of a method of simulating a second network node;

FIG. 3 shows an example of an access node communicating with User Equipment (UE);

FIG. 4 shows an example of a functional division between a REC and RE;

FIG. 5 illustrates an example of testing Radio Equipment (RE) using a Radio Equipment Controller (REC) simulator;

FIG. 6 illustrates an example of testing a Radio Equipment Controller (REC) using a Radio Equipment (RE) simulator;

FIG. 7 illustrates an example of testing of frequency errors in testing a Radio Equipment Controller (REC) using a Radio Equipment (RE) simulator;

FIG. 8 is a schematic of an example of an apparatus for simulating a first network node;

FIG. 9 is a schematic of an example of an apparatus for testing a second network node;

FIG. 10 is a schematic of an example of an apparatus for simulating a second network node; and

FIG. 11 is a schematic of an example of an apparatus for testing a first network node.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

When developing a network node such as a REC or RE, there may be a need to verify the performance of the implementation, or otherwise test that the network node is operating correctly. A complete test setup may in some examples involve using both a REC and RE. However, the REC development team might be different from the RE development team, and may even belong to different companies. This can make the testing difficult and time consuming. It can also make it difficult to identify in which unit any potential fault is located.

Examples of this disclosure are described in the context of network nodes comprising a Radio Equipment Controller (REC) or Radio Equipment (RE). However, the examples disclosed herein may also apply to other nodes, such as for example a Distributed Unit (DU) or Radio Unit (RU) respectively, or an O-DU or O-RU respectively. The terms REC, DU and O-DU may be used interchangeably. Additionally, the terms RE, RU and O-RU are used interchangeably.

To make testing more efficient, it is preferred that as much as possible of the testing can be done separately on the REC and the RE. To enable this, the functional split between the REC and RE should be done in a way that separates the functionality in a clear way, both in order to be able to identify which unit that is faulty, and to enable individual testing of the two units.

One example way to split the functionality is to put the channel estimation and equalization in the RE, and the demodulation and decoding in the REC. This enables well defined RE-simulators (to test the REC) and REC-simulators (to test RE). The REC-simulator may for example implement specific, well-defined and well-known demodulator and decoder algorithms. The RE-simulator may for example have a signal generator that would generate signals corresponding to the IQ-data and SNIR measurements that the REC is expecting.

These specific, well-defined and well-known REC-and RE-simulators could be used both for general testing, and formal conformance/compliance testing.

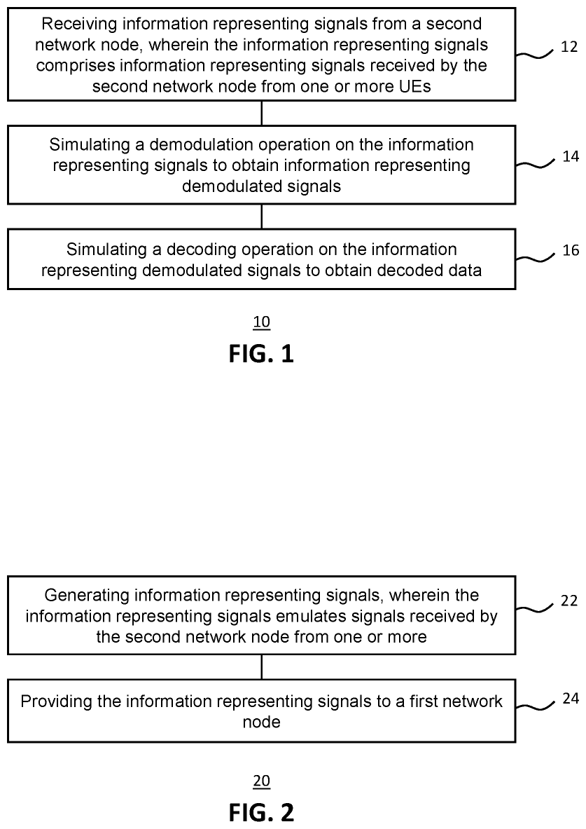

FIG. 1 is a flow chart of an example of a method 10 of simulating a first network node. The method comprises, in step 12, receiving information representing signals from a second network node, wherein the information representing signals comprises information representing signals received by the second network node from one or more User Equipments (UEs). Step 14 of the method 10 comprises simulating a demodulation operation on the information representing signals to obtain information representing demodulated signals. Step 16 of the method 10 comprises simulating a decoding operation on the information representing demodulated signals to obtain decoded data.

In some examples, the first network node comprises a Radio Equipment Controller (REC) or a Distributed Unit (DU). Additionally or alternatively, in some examples, the second network node comprises Radio Equipment (RE) or a Radio Unit (RU).

The method 10 may in some examples comprise simulating a layer demapping operation on the information representing signals before simulating the demodulation operation. Thus, for example, the layer demapping operation obtains information representing demapped signals, and step 14 of the method 10 may thus comprise for example simulating a demodulation operation on the information representing demapped signals to obtain the information representing demodulated signals.

In some examples, the information representing signals received by the second network node from one or more UEs comprises information representing in-phase and quadrature (IQ) components of signals received by the second network node from one or more UEs.

The information representing signals from the second network node may be received for example according to a Common Public Radio Interface (CPRI), eCPRI or IEEE1914.3 specification.

In some examples, the method may comprise determining, based on the decoded data, at least one of the following:
a test result of testing the second network node;
whether the second network node is operating correctly;
performance of the second network node;
reliability of the second network node.

Thus, for example, the decoded data may be used to determine whether the second network node is operating correctly or if it is behaving abnormally, is faulty etc. In some examples, determining the test result of testing the second network node comprises comparing the decoded data to predetermined data. The predetermined data may be the data that is received by the second network node as the signals from one or more UEs. The predetermined data may be for example specified or test data, or may alternatively be for example be the actual payload data output from the UE(s). This may for example then be sent to a “comparing” device, e.g. either in the REC-simulator or in a separate apparatus.

Simulating a decoding operation in step 16 of the method 10 may in some examples comprise simulating convolutional decoding, block decoding, a Viterbi decoder, a Reed-Solomon decoder and/or a belief propagation decoder, or any other suitable kind of decoder.

The information representing signals may in some examples comprises information representing the Signal to Interference & Noise Ratio (SINR) of the signals. Thus, in some examples, simulating a demodulation operation may in some examples comprise simulating Log Likelihood Ratio (LLR) demodulation.

In some examples, the information representing signals comprises information identifying a frequency error in the signals.

Some examples of this disclosure include a method of testing a second network node, such as a RE, DU or O-DU. The method comprises performing any of the examples of the method 10 of simulating a first network node described herein. The method also comprises determining a test result of testing the second network node based on the decoded data.

FIG. 2 is a flow chart of an example of a method 20 of simulating a second network node. The method 20 comprises, in step 22, generating information representing signals, wherein the information representing signals emulates signals received by the second network node from one or more User Equipments (UEs). That is, for example, the information representing signals appears similar to signals received by a real (i.e. non-simulated) second network node (e.g. RE or RU). Step 24 of the method comprises providing the information representing signals to a first network node.

In some examples, the first network node comprises a Radio Equipment Controller (REC) or a Distributed Unit (DU). Additionally or alternatively, in some examples, the second network node comprises Radio Equipment (RE) or a Radio Unit (RU).

The information representing signals may in some examples emulates information representing in-phase and quadrature (IQ) components of signals received by the second network node from one or more UEs.

In some examples, the information representing signals from the second network node is provided to the first network node according to a Common Public Radio Interface (CPRI), eCPRI or IEEE1914.3 specification.

In some examples, the method 20 comprises obtaining, from the first network node, decoded data based on the information representing signals, and determining, based on the decoded data, at least one of the following:
a test result of testing the first network node;
whether the first network node is operating correctly;
performance of the first network node;
reliability of the first network node.

Determining the test result of testing the first network node may comprise for example comparing the decoded data to predetermined data.

In some examples, generating the information representing signals in step 22 comprises encoding data to obtain encoded data, wherein the information representing signals is based on the encoded data. Encoding the data may comprise for example performing convolutional encoding or block encoding on the data. The data may predetermined (e.g. specified as suggested above) or pseudorandom data in some examples.

In some examples, the information representing signals comprises including information identifying a Signal to Interference & Noise Ratio (SINR) of the signals in the information representing signals.

Generating the information representing signals in step 22 may comprise in some examples including a frequency error in the information representing signals. The method 20 may this comprise for example providing information identifying the frequency error to the first network node. Additionally or alternatively, in some examples, generating the information representing signals in step 22 may comprise including noise in the information representing signals to simulate interference and/or thermal noise. Additionally or alternatively, in some examples, generating the information representing signals in step 22 may comprise including amplitude scaling and/or phase rotation of the information representing signals to simulate radio fading.

The information representing signals generated in step 22 may in some examples comprise one or more layers.

Examples of this disclosure may also include method of testing a first network node, such as a REC, DU or O-DU. The method comprises performing any of the examples of the method 20 of simulating a second network node as described herein. The method may also comprise determining a test result of testing the first network node based on an output of the first network node. The output of the first network node may comprise for example decoded data based on the information representing signals.

Specific example embodiments will now be described.

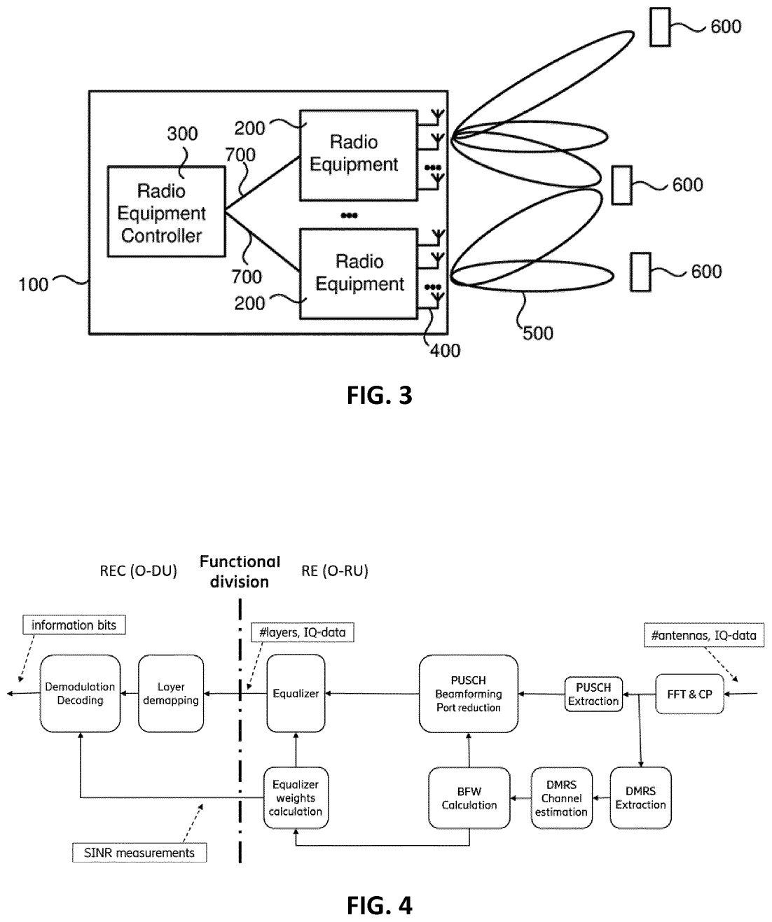

FIG. 3 shows an example of an access node 100, with REC 300 and REs 200, communicating with User Equipment (UE) 600. There is a lower layer split interface 700 between REC 300 and REs 200.

FIG. 4 shows an example of a functional division between a REC and RE. This shows a proposed lower layer split currently under consideration by O-RAN WG4. It has beamforming/port reduction, channel estimation, beamforming weight calculation, equalization in the RE, and demodulation and decoding in the REC. Note that in O-RAN, the REC is called O-DU (O-RAN Distributed Unit) and the RE is called O-RU (O-RAN Radio Unit). Thus these terms, and DU and RU respectively, are used interchangeably herein. Any of the functions shown in FIG. 4 may be implemented in the method 10 or the method 20 as appropriate.

From the right of FIG. 4, functions in RE (O-RU), one IQ-data stream for each of the receiver antennas is the input the FFT and cyclic prefix removal block. For an example Massive MIMO product operating in the 2-3.5 GHz frequency range, the number of antenna IQ-data streams may be in the order of 64. After the beamforming/port reduction/equalization, the number of IQ-data streams is reduced to the number of layers scheduled.

Note that the blocks in the Figures should be seen as conceptional or functional blocks. The interface between the REC and the RE, denoted as “Functional division” in FIG. 4, is significant. An actual implementation can for example implement beamforming/port reduction and equalization as one unit. And similarly, the beamforming weights calculation and the equalizer weights calculation can be implemented as one unit.

To make testing more efficient, in some examples, as much as possible of the testing can be done separately on the REC and the RE. To enable this, the functional split between the REC and RE may be done in a way that separates the functionality in a clear way, both in order to be able to identify which unit that is faulty, and to enable individual testing of the two units.

An example way to split the functionality is to put the channel estimation and equalization in the RE, and the demodulation and decoding in the REC. This will enable well defined RE-simulators (to test the REC) and REC-simulators (to test RE). The REC-simulator may for example implement specific, well-defined demodulator and decoder algorithms. The RE-simulator may for example have a signal generator that would generate multiple signals corresponding to the IQ-data and SNIR measurements that the REC is expecting. These specific, well-defined and well-known REC-and RE-simulators could both be used for general testing, and formal conformance/compliance testing.

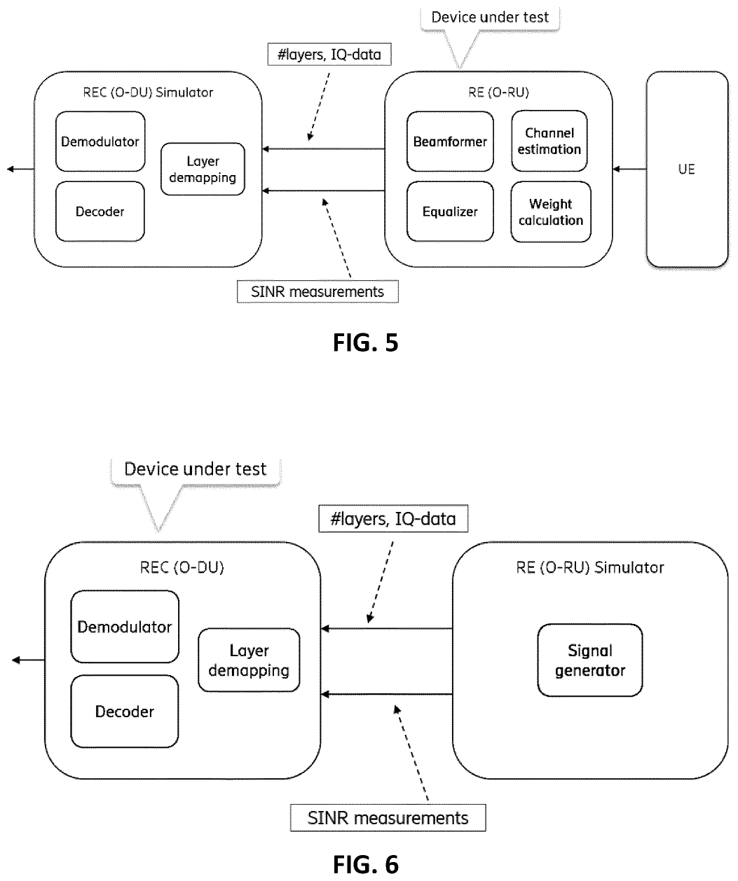

FIG. 5 illustrates an example of testing Radio Equipment (RE) using a Radio Equipment Controller (REC) simulator. The RE is the device under test. In order for the REC-simulator to be used for conformance/compliance testing, its functionality may be standardized in some examples. That is, for example, each of the functions shown in this example, “layer mapping”, “demodulator” and “decoder”, may be specified.

Layer mapping: In the case of a 3GPP compliant system, the layer mapping may be specified by 3GPP. For example, for the NR standard, layer mapping is specified in 3GPP TS 38.211 V17.1.0, “NR; Physical channels and modulation.”

Demodulator: A demodulator algorithm may be selected, for example the Log-Likelihood Ratio (LLR) Demodulation algorithm, see for example https://www.mathworks.com/help/comm/ug/log-likelihood-ratio-llr-demodulation.html.

Decoder: Depending on the signals/channels being testing, different coding schemes can be used. For example, convolutional coding and block coding, see for example https://www.mathworks.com/help/comm/error-detection-and-correction.html. For each used coding scheme, a simple, straight-forward decoder should be selected and specified. For example, a Viterbi decoder may be used to decode convolutional codes, or a Reed-Solomon decoder may be used, etc.

FIG. 6 illustrates an example of testing a Radio Equipment Controller (REC) using a Radio Equipment (RE) simulator. The REC is the device under test.

In this example, the “signal generator” should generate the signals that are needed to test the REC. This includes the IQ-data per layer and the SINR measurements that the REC expects.

In some examples, the signal generation includes the steps of:
Generating pseudo random payload data for each UE being simulated.
Encoding of the payload data according to the system standard, e.g., the 3GPP specification.
Splitting the encoded data onto multiple layers according to the system standard, e.g., the 3GPP specification.
Optionally, scale the amplitude and/or rotate the phase of the per-layer data, to simulate radio fading.
Optionally, adding noise to the per-layer data, to simulate interference and thermal noise.
Based on the applied amplitude scaling and/or phase rotation, and added noise, generate the SINR measurements.

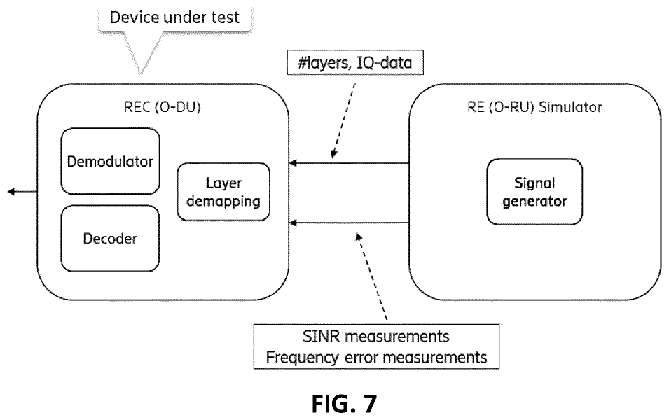

FIG. 7 illustrates an example of testing of frequency errors in testing a Radio Equipment Controller (REC) using a Radio Equipment (RE) simulator. To test the impact of frequency errors, the following additional steps may be implanted, for example in the method 20, or in a second network node simulator or RE/RU/O-RU simulator:
Configure the wanted frequency error in the simulator
The simulator applies a frequency error to the per-layer data
The simulator reports the frequency error to the REC over the interface between the RE and REC.
The REC performs the reception using this frequency error information.

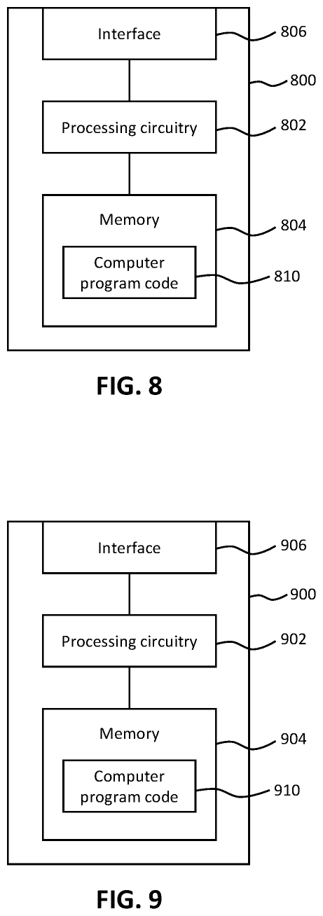

FIG. 8 is a schematic of an example of an apparatus 800 for simulating a first network node. The apparatus may in some examples be comprised in one or more nodes in a network or a SDN controller. The apparatus 800 comprises processing circuitry 802 (e.g. one or more processors) and a memory 804 in communication with the processing circuitry 802. The memory 804 contains instructions, such as computer program code 810, executable by the processing circuitry 802. The apparatus 800 also comprises an interface 806 in communication with the processing circuitry 802. Although the interface 806, processing circuitry 802 and memory 804 are shown connected in series, these may alternatively be interconnected in any other way, for example via a bus.

In one embodiment, the memory 804 contains instructions executable by the processing circuitry 802 such that the apparatus 800 is operable/configured to receive information representing signals from a second network node, wherein the information representing signals comprises information representing signals received by the second network node from one or more User Equipments (UEs), simulate a demodulation operation on the information representing signals to obtain information representing demodulated signals, and simulate a decoding operation on the information representing demodulated signals to obtain decoded data. In some examples, the apparatus 800 is operable/configured to carry out the method 10 described above with reference to FIG. 1.

FIG. 9 is a schematic of an example of an apparatus 900 for testing a second network node. The apparatus may in some examples be comprised in one or more nodes in a network or a SDN controller. The apparatus 900 comprises processing circuitry 902 (e.g. one or more processors) and a memory 904 in communication with the processing circuitry 902. The memory 904 contains instructions, such as computer program code 910, executable by the processing circuitry 902. The apparatus 900 also comprises an interface 906 in communication with the processing circuitry 902. Although the interface 906, processing circuitry 902 and memory 904 are shown connected in series, these may alternatively be interconnected in any other way, for example via a bus.

In one embodiment, the memory 904 contains instructions executable by the processing circuitry 902 such that the apparatus 900 is operable/configured to receive information representing signals from a second network node, wherein the information representing signals comprises information representing signals received by the second network node from one or more User Equipments (UEs), simulate a demodulation operation on the information representing signals to obtain information representing demodulated signals, simulate a decoding operation on the information representing demodulated signals to obtain decoded data; and determining a test result of testing the second network node based on the decoded data. In some examples, the apparatus 900 is operable/configured to carry out the method 10 described above with reference to FIG. 1.

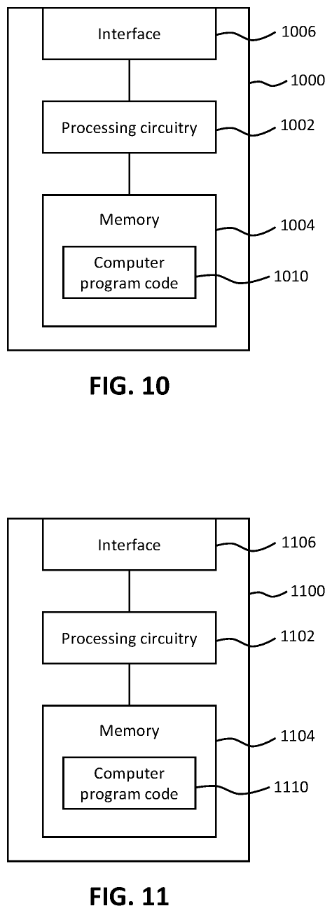

FIG. 10 is a schematic of an example of an apparatus 1000 for simulating a second network node. The apparatus may in some examples be comprised in one or more nodes in a network or a SDN controller. The apparatus 1000 comprises processing circuitry 1002 (e.g. one or more processors) and a memory 1004 in communication with the processing circuitry 1002. The memory 1004 contains instructions, such as computer program code 1010, executable by the processing circuitry 1002. The apparatus 1000 also comprises an interface 1006 in communication with the processing circuitry 1002. Although the interface 1006, processing circuitry 1002 and memory 1004 are shown connected in series, these may alternatively be interconnected in any other way, for example via a bus.

In one embodiment, the memory 1004 contains instructions executable by the processing circuitry 1002 such that the apparatus 1000 is operable/configured to generate information representing signals, wherein the information representing signals emulates signals received by a second network node from one or more User Equipments (UEs), and provide the information representing signals to a first network node. In some examples, the apparatus 1000 is operable/configured to carry out the method 20 described above with reference to FIG. 2.

FIG. 11 is a schematic of an example of an apparatus 1100 for testing a first network node. The apparatus may in some examples be comprised in one or more nodes in a network or a SDN controller. The apparatus 1100 comprises processing circuitry 1102 (e.g. one or more processors) and a memory 1104 in communication with the processing circuitry 1102. The memory 1104 contains instructions, such as computer program code 1110, executable by the processing circuitry 1102. The apparatus 1100 also comprises an interface 1106 in communication with the processing circuitry 1102. Although the interface 1106, processing circuitry 1102 and memory 1104 are shown connected in series, these may alternatively be interconnected in any other way, for example via a bus.

In one embodiment, the memory 1104 contains instructions executable by the processing circuitry 1102 such that the apparatus 1100 is operable/configured to generate information representing signals, wherein the information representing signals emulates signals received by a second network node from one or more User Equipments (UEs), provide the information representing signals to a first network node, and determine a test result of testing the first network node based on an output of the first network node. In some examples, the apparatus 1100 is operable/configured to carry out the method 20 described above with reference to FIG. 2.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method of simulating a first network node, the method comprising:
receiving information representing signals from a second network node, wherein the information representing signals comprises information representing signals received by the second network node from one or more User Equipments (UEs);
simulating a demodulation operation on the information representing signals to obtain information representing demodulated signals; and
simulating a decoding operation on the information representing demodulated signals to obtain decoded data.

2. The method of claim 1, wherein the first network node comprises a Radio Equipment Controller (REC) or a Distributed Unit (DU).

3. The method of claim 1, wherein the second network node comprises Radio Equipment (RE) or a Radio Unit (RU).

4. The method of claim 1, further comprising simulating a layer demapping operation on the information representing signals before simulating the demodulation operation.

5. The method of claim 1, wherein the information representing signals received by the second network node from one or more UEs comprises information representing in-phase and quadrature (IQ) components of signals received by the second network node from one or more UEs.

6. The method of claim 1, wherein the information representing signals from the second network node is received according to a Common Public Radio Interface (CPRI), eCPRI or IEEE1914.3 specification.

7. The method of claim 1, further comprising determining, based on the decoded data, at least one of the following:
a test result of testing the second network node;
whether the second network node is operating correctly;
performance of the second network node;
reliability of the second network node.

8. The method of claim 7, wherein determining the test result of testing the second network node comprises comparing the decoded data to predetermined data.

9. The method of claim 1, wherein simulating a decoding operation comprises simulating one or more of convolutional decoding, block decoding, a Viterbi decoder, a Reed-Solomon decoder and a belief propagation decoder.

10. The method of claim 1, wherein the information representing signals comprises information representing the Signal to Interference & Noise Ratio (SINR) of the signals, and wherein simulating a demodulation operation comprises simulating Log Likelihood Ratio (LLR) demodulation.

11. (canceled)

12. The method of claim 1, wherein the information representing signals comprises information identifying a frequency error in the signals.

13. The method of claim 1, further comprising:
determining a test result of testing the second network node based on the decoded data.

14. A method of simulating a second network node, the method comprising:
generating information representing signals, wherein the information representing signals emulates signals received by the second network node from one or more User Equipments (UEs); and
providing the information representing signals to a first network node.

15. (canceled)

16. (canceled)

17. The method of claim 14, wherein the information representing signals emulates information representing in-phase and quadrature (IQ) components of signals received by the second network node from one or more UEs.

18. (canceled)

19. The method of claim 14, further comprising obtaining, from the first network node, decoded data based on the information representing signals, and determining, based on the decoded data, at least one of the following:
a test result of testing the first network node;
whether the first network node is operating correctly;
performance of the first network node;
reliability of the first network node.

20.-23. (canceled)

24. The method of claim 14, wherein the information representing signals comprises including information identifying a Signal to Interference & Noise Ratio (SINR) of the signals in the information representing signals.

25. The method of claim 14, wherein generating the information representing signals comprises including a frequency error in the information representing signals, the method further comprising providing information identifying the frequency error to the first network node.

26. (canceled)

27. The method of claim 14, wherein generating the information representing signals comprises including noise in the information representing signals to simulate one or both of interference and thermal noise.

28. The method of claim 14, wherein generating the information representing signals comprises including amplitude scaling and/or phase rotation of the information representing signals to simulate radio fading.

29.-34. (canceled)

35. An apparatus for simulating a first network node, the apparatus comprising a processor and a memory, the memory containing instructions executable by the processor such that the apparatus is operable to:
receive information representing signals from a second network node, wherein the information representing signals comprises information representing signals received by the second network node from one or more User Equipments (UEs);
simulate a demodulation operation on the information representing signals to obtain information representing demodulated signals; and
simulate a decoding operation on the information representing demodulated signals to obtain decoded data.

36.-52. (canceled)
